(19) United States
(12) Patent Application Publication
(10) Pub. No.: US 2014/0156030 A1
(43) Pub. Date: Jun. 5, 2014

(54) REMOTE CONTROLLER MANAGING DEVICE, CONTROL METHOD, AND COMPUTER PROGRAM PRODUCT

(71) Applicants: Mitsuhiko Sakai, Hakui-shi (JP); Kabushiki Kaisha Toshiba, Tokyo (JP)

(72) Inventors: Masayuki Okamoto, Kanagawa (JP); Masaru Sakai, Ishikawa (JP); Hiroko Fujii, Tokyo (JP); Akira Miyazawa, Saitama (JP); Daisuke Sano, Tokyo (JP)

(73) Assignee: Kabushiki Kaisha Toshiba, Tokyo (JP)

(21) Appl. No.: 14/024,393

(22) Filed: Sep. 11, 2013

(30) Foreign Application Priority Data
Nov. 30, 2012 (JP) 2012-263705

(51) Int. Cl. G05B 99/00

(52) U.S. Cl. CPC G05B 99/00
USPC 700/20

(57) ABSTRACT

According to one embodiment, a remote controller managing device is configured to output an operation instruction signal for controlling a target control device in accordance with operation instructions from a plurality of remote controllers, respectively, for controlling the target control device. The remote controller managing device includes a conflict determining module and a controller. The conflict determining module is configured to determine whether the operation instructions of the remote controllers conflict with each other when the operation instructions are issued by the remote controllers. The controller is configured to control the target control device so as to correspond to one of the operation instructions of one of the remote controllers with a higher priority order based on predetermined priority orders when the conflict determining module determines that the operation instructions conflict with each other.

### CROSS-REFERENCE TO RELATED APPLICATIONS

This application is based upon and claims the benefit of priority from Japanese Patent Application No. 2012-263705, filed Nov. 30, 2012, the entire contents of which are incorporated herein by reference.

### FIELD

Embodiments described herein relate generally to a remote controller managing device, a control method, and a computer program product.

### BACKGROUND

Recently, it is becoming popular to operate a content reproduction device such as a television by a remote controller device.

With the spread of the remote controller device, it is becoming common to simultaneously use a plurality of remote controller devices at the same location, for a single receiver provided in a single device.

In addition, there is known an information device, such as a smart phone, which has a function as a remote controller.

However, conventionally, if there exist a plurality of remote controller devices with similar functions, the remote controllers are treated on an equal basis. Therefore, when multiple users operate the remote controllers, the later performed operation becomes valid and thereby operations conflict with each other. This lowers the operability of the device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a general configuration of a television viewing system according to an embodiment;

FIGS. 2A and 2B are exemplary diagrams of examples of screen displays of an operating terminal in accordance with whether a user is logged in to the operating terminal, and FIG. 2A illustrates a common mode while FIG. 2B illustrates a logged in mode, in the embodiment;

FIG. 3 is an exemplary diagram of a priority table stored in a user manager and storing user IDs and priority orders, in the embodiment;

FIG. 4 is an exemplary diagram of a content managing table for storing content management states, in the embodiment;

FIG. 5 is an exemplary flowchart of a conflict detecting process of a remote controller managing device in the embodiment;

FIG. 6 is an exemplary explanatory diagram of one example of a case when screen display contents conflict with each other, in the embodiment;

FIG. 7 is an exemplary explanatory diagram of one example of an overall display, in the embodiment;

FIG. 8 is an exemplary explanatory diagram of one example of when an operation authority is transferred from an operating terminal of a user holding the operation authority to an operating terminal of other user, in the embodiment;

FIG. 9 is an exemplary diagram for explaining resolving of conflict between content operations; and

FIG. 10 is an exemplary explanatory diagram for explaining resolving of conflict of the operation authority.

### DETAILED DESCRIPTION

In general, according to one embodiment, a remote controller managing device is configured to output an operation instruction signal for controlling a target control device in accordance with operation instructions from a plurality of remote controllers, respectively, for controlling the target control device. The remote controller managing device comprises a conflict determining module and a controller. The conflict determining module is configured to determine whether the operation instructions of the remote controllers conflict with each other when the operation instructions are issued by the remote controllers. The controller is configured to control the target control device so as to correspond to one of the operation instructions of one of the remote controllers with a higher priority order based on predetermined priority orders when the conflict determining module determines that the operation instructions conflict with each other.

An embodiment is described below with reference to the accompanying drawings.

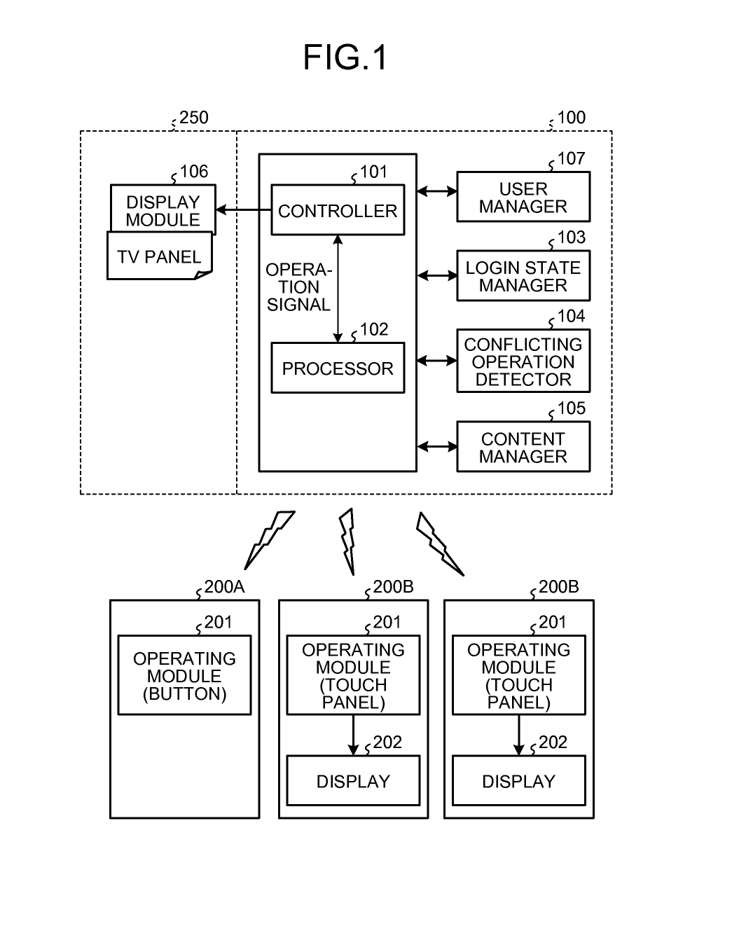

FIG. 1 is a block diagram of a general configuration of a television viewing system according to the embodiment.

This television viewing system 10 comprises a remote controller managing device 100, a plurality of operating terminals 200, and a television 250. The operating terminals 200 each function as a remote controller. The television 250 has a large-size display that is expected to be viewed by a plurality of people simultaneously.

The remote controller managing device 100 comprises a controller 101, a processor 102, a login state manager 103, a conflicting operation detector 104, a content manager 105, and a user manager 107. The controller 101 accepts an operation and controls a television screen. The processor 102 transmits and receives an operation signal to and from the operating terminal 200. The login state manager 103 manages a login state of each terminal. The conflicting operation detector 104 detects conflict (contention) between operations or display contents of the terminals.

The remote controller managing device 100 has a user managing function for managing users by determining which specific user has logged in, for each terminal with the remote control function.

Additionally, the remote controller managing device 100 has a login state managing function for managing the login state of the users for each of the connected operating terminals 200 or screen display devices.

The login state managing function is a function for managing the users by identifying a specific user who has logged in to a specific terminal connected to a screen on which operation contents are displayed, regardless of which one of the operating terminals 200 (remote controller) is operated.

Operation modes defined by the login state include at least one of a shared mode or a login mode. Here, in the login mode, a user has logged in to the operating terminal by a login operation.

The operating terminal 200 that cooperates with the remote controller managing device 100 comprises an operating module 201 and a display 202.

The operating terminals 200 comprise an operating terminal 200A and a plurality of (two in FIG. 1) tablet terminals 200B with a remote control function. Specifically, the operating terminal 200A is configured as a television remote controller comprising a plurality of pushbuttons that function as an operating module. On the other hand, each of the tablet terminals 200B comprises an input module provided with a touch panel that functions as an operating module and a display that functions as a display module.

Each user who operates the operating terminal 200 can operate the remote controller managing device 100 (a television or a set top box) using the operating terminal 200 (remote controller) he or she uses.

Further, if the operating terminal 200 comprises a display 202, it can be selected whether to display the operation result on the display 202 of the operating terminal or on a display module 106 (large display) of the television 250.

In addition, each content can be associated with one or more user IDs.

Specifically, when a user explicitly performs a recording operation during a login session or places another file on a storage that can be managed by the television 250, a user ID by which the operation is performed on the target content is associated with the target content.

Further, in a state other than the login state, the target content may be defined as shared content. In this case, a user ID representing “shared” may be associated with the target content, or no user ID may be associated therewith.

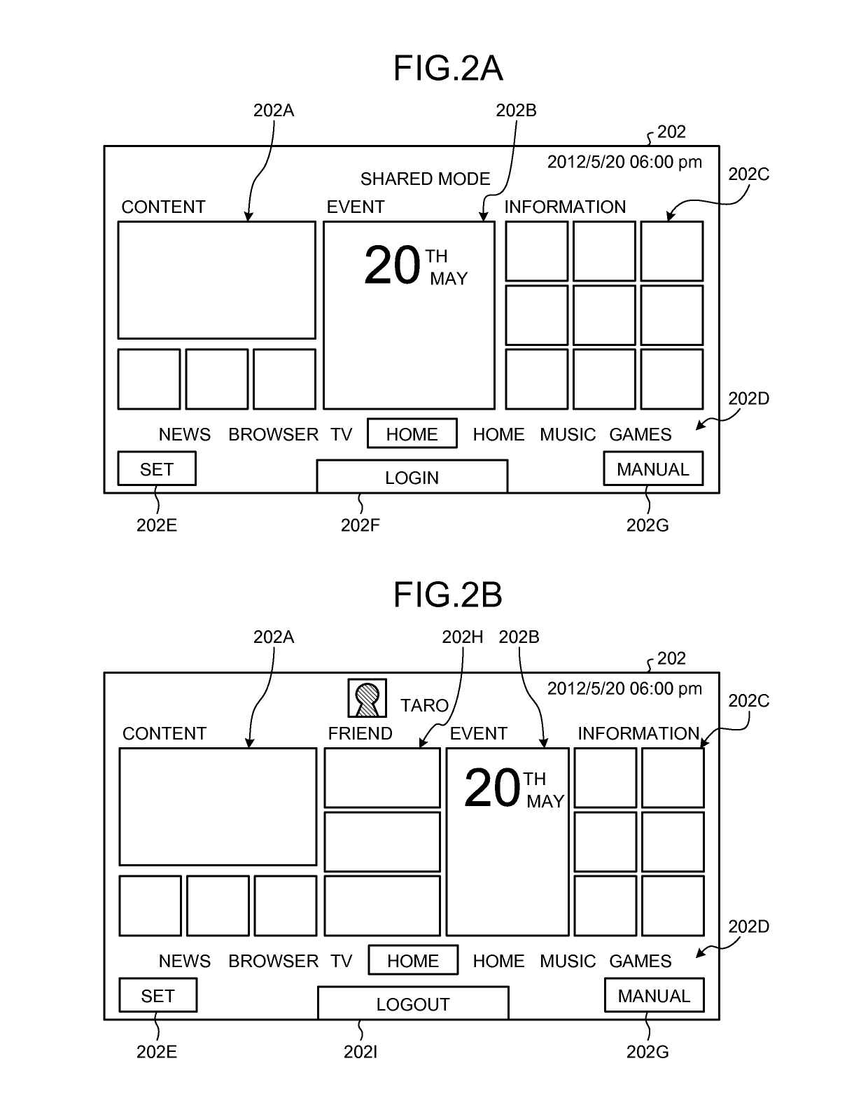

FIGS. 2A and 2B are exemplary explanatory diagrams of screen display examples of the operating terminal in accordance with whether the user has been logged in to the operating terminal.

FIG. 2A is an exemplary screen display of the display 202 of the operating terminal 200 when none of the users have logged in to the operating terminal 200.

Here, the display 202 cooperates with the operating module 201 to function as a touch panel display.

When none of the users have logged in to the operating terminal 200, the screen of the “shared mode” or the “family mode”, which is not for specific individual, is displayed.

As illustrated in FIG. 2A, the display 202 of the operating terminal 200 to which none of the users has logged in comprises, for example, a content display area 202A, an event display area 202B, an information display area 202C, a selective information display area 202D, a set button display area 202E, a login button display area 202F, and a manual button display area 202G. The content display area 202A selectably displays a content to be reproduced. The event display area 202B selectably displays a calendar or various events on the operating date. The information display area 202C selectably displays various types of information. The selective information display area 202D indicates selected or selectable display contents (news, browser, TV, home, video, music, games). The set button display area 202E displays a set button that is to be operated when displaying a set screen and allows the set button to be operated. The login button display area 202F displays a login button that is to be operated for switching to a login screen and allows the login button to be operated. The manual button display area 202G causes a manual to be displayed and allows the manual to be operated.

FIG. 2B is an exemplary screen display in the display 202 of the operating terminal 200 when one of the users has logged in.

When one of the users has logged in, a screen indicating that a specific user (“Taro” in the example illustrated in FIG. 2B) has logged is displayed, as illustrated in FIG. 2B. If an operation is performed to record a television program under this condition, the television program is treated as being recorded by the user “Taro”.

As illustrated in FIG. 2B, the display 202 of the operating terminal 200 of when one of the users has logged in, comprise, for example, the content display area 202A, a friend information display area 202H, the event display area 202B, the information display area 202C, the selective information display area 202D, the set button display area 202E, a logout button display area 202I, and the manual button display area 202G. Specifically, the content display area 202A selectably displays a content to be reproduced. The friend information display area 202H selectably displays information (e.g., email and social network service) on friends of the user. The event display area 202B selectably displays a calendar or various events on the operating day. The information display area 202C selectably displays various types of information. The selective information display area 202D indicates selected or selectable display contents (news, browser, TV, home, video, music, games). The set button display area 202E displays a set button that is to be operated when displaying a set screen and allows the set button to be operated. The logout button display area 202I displays a logout button that is to be operated for switching to a logout screen and allows the logout button to be operated. The manual button display area 202G causes a manual to be displayed and allows the manual to be operated.

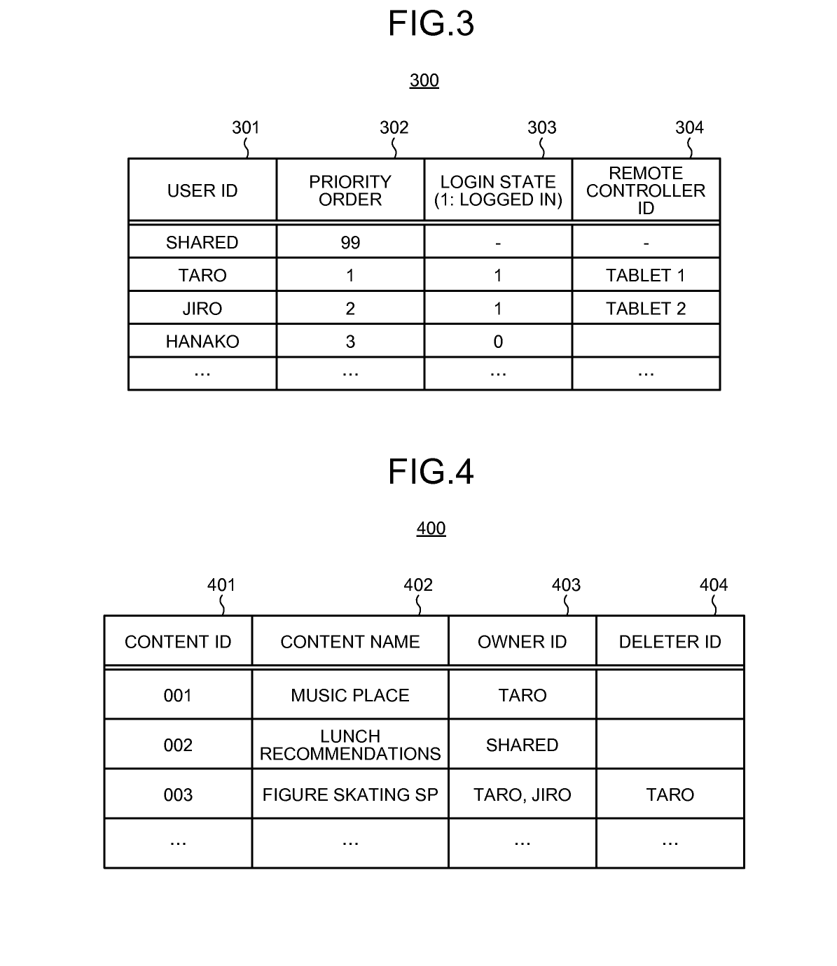

FIG. 3 is an exemplary diagram for illustrating a priority table stored in the user manager and storing user IDs and priority orders.

In FIG. 3, the priority table 300 comprises user ID data 301, priority order data 302, login state data 303, and remote controller ID data 304. Specifically, the user ID data 301 stores therein user IDs. The priority order data 302 stores therein the priority orders. The login state data 303 indicates whether a user identified by the user ID has logged in. The remote controller ID data 304 stores therein the remote controller ID that identifies a specific operating terminal 200 used by the user who has logged in.

It is to be noted that, although the list of user IDs managed by the remote controller managing device 100 is required, other items are not necessarily required depending on embodiments. The priority order is used when a user specific priority is to be provided. The login state indicates whether each user has logged in. The remote controller ID denotes the ID assigned to the operating terminal 200 used during the login session.

FIG. 4 is an exemplary diagram for illustrating a content managing table for storing management states of contents.

A content managing table 400 comprises content ID data 401, content name data 402, owner ID data 403, and deleter ID data 404. Specifically, the content ID data 401 stores therein IDs that uniquely identify content. The content name data 402 indicates the name of the content. The owner ID data 403 stores therein user IDs of one or a plurality of users who can record, place, or use the content. The deleter ID data 404 stores therein deleter IDs that are hidden as described later.

The items other than the content ID data may not necessarily be required depending on embodiments.

Conflict among operations by a plurality of users will be described below.

When each of the users performs an operation, conflicts such as those described in the following items (a) to (c) might occur.

(a) Conflicts Among Content Operations

This corresponds, for example, to a case when an operation to reproduce a recorded program is being performed by a remote controller A while an operation to delete the recorded program is performed by a remote controller B.

(b) Conflicts Among Login States and Operation Authorities

This is the conflict among operation modes, and corresponds, for example, to a case when a displaying is performed by a display of TV based on the understanding that the user A has logged in, while an operation is performed by a remote controller B to which the user B has logged in.

(c) Conflicts Among Display Contents

The remote controller managing device 100 in the embodiment detects these types of conflicts.

In the following, an operation of the embodiment related to a method for detecting the conflicts and a method for handling the detected conflicts is explained.

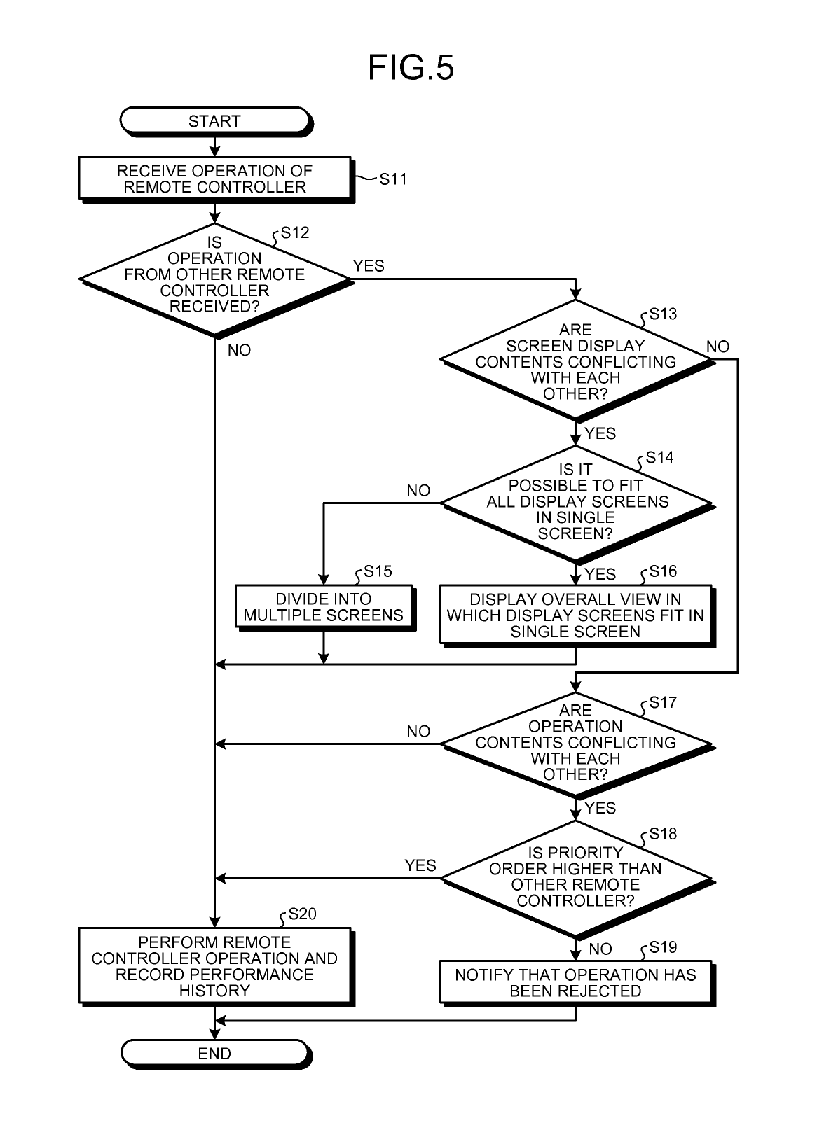

FIG. 5 is a flowchart of a conflict detecting process of the remote controller managing device in the embodiment.

It is noted that the determinations and the conditions in FIG. 5 may be reordered and performed, or simultaneously performed in parallel with each other.

The remote controller managing device 100 receives a remote controller operation from the operating terminal 200 (S11).

Upon receipt of the remote controller operation from one of the operating terminals 200, the remote controller managing device 100 determines whether a remote controller operation from other operating terminal 200 is received (S12).

When it is determined in S12 that the remote controller operation from other operating terminal 200 has not been received (No at S12), the remote controller managing device 100 executes the received remote controller operation content, records an execution history, and terminates the conflict detecting process (S20).

If it is determined at S12 that the remote controller operation has been received (Yes at S12), the remote controller managing device 100 determines whether the screen display contents conflict with each other (S13).

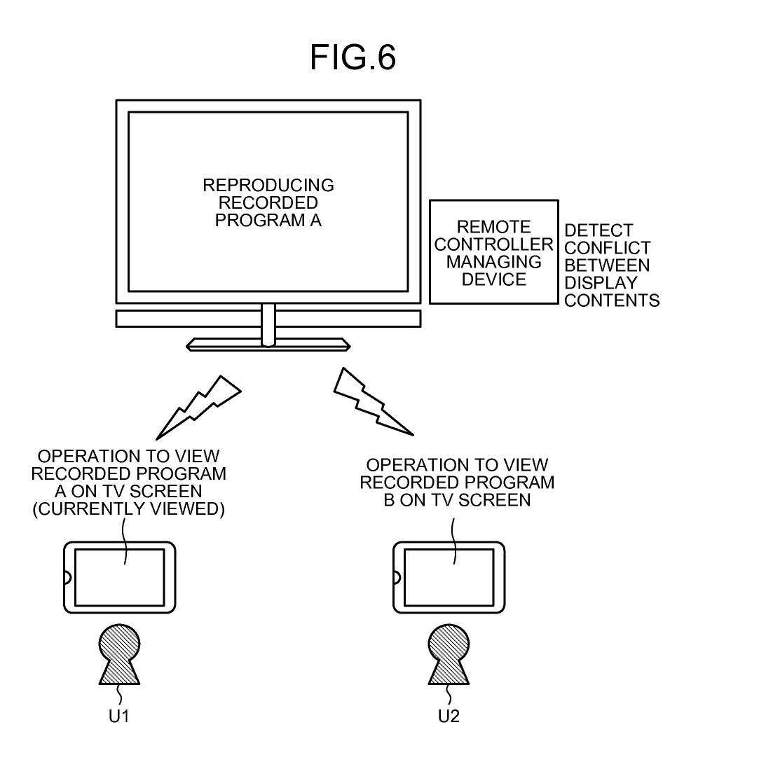

FIG. 6 is an exemplary explanatory diagram of one example of a case when the screen display contents conflict with each other.

In the example illustrated in FIG. 6, while a first user U1 has performed an operation to view a recorded program A on a TV screen and the recorded program A has been reproduced on the TV screen, a second user U2 performs an operation to view a recorded program B on the TV screen.

This results in a conflict between the screen display contents.

If it is determined at S13 that the screen display contents conflict with each other (Yes at S13), the remote controller managing device 100 determines whether it is possible to draw (display) display screens of all users involved in the conflicting screen display contents, in a single screen (S14).

If it is determined at S14 that it is not possible to draw (display) the display screens of all users within a single screen (No at S14), the remote controller managing device 100 performs the displaying on a plurality of divided screens (S15). Then, the process proceeds to S20 and the remote controller managing device 100 performs the received remote controller operation and records the performance history before terminating the conflict detecting process (S20).

For example, for two users with priority orders identical to each other, the recorded programs may be displayed and output in parallel with each other with images reproduced on two divided screens and voice output to respective terminals.

Such an arrangement allows a plurality of users to perform respective remote controller operations for reproduction without being interrupted by each other.

If it is determined at S14 that the it is possible to draw (display) the display screens of all users within a single screen (Yes at S14), the remote controller managing device 100 provides an overall display in which the display screens are fit within a single screen (S16).

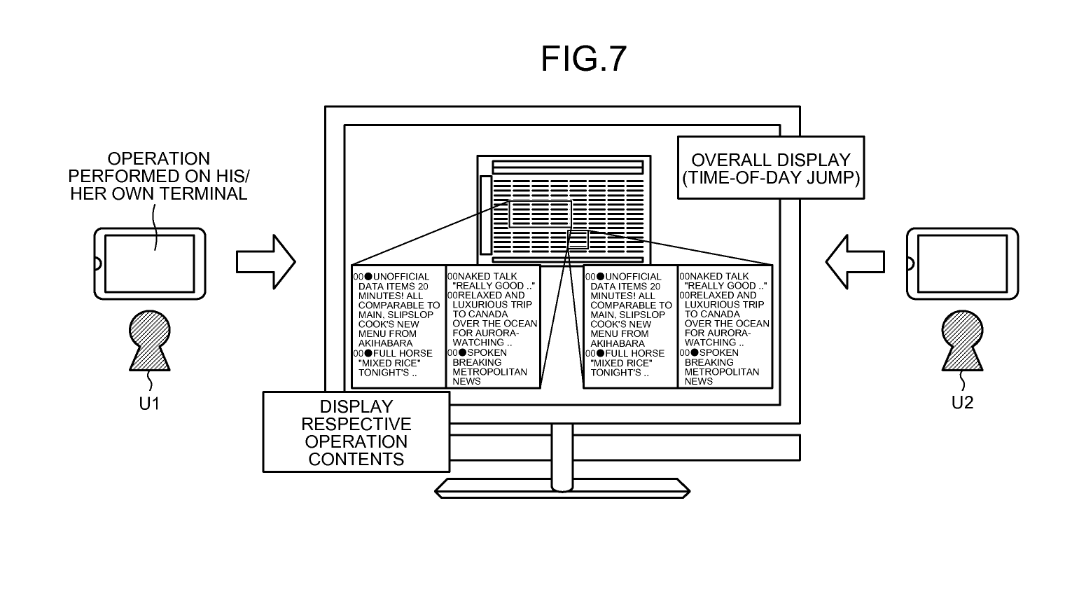

FIG. 7 is an exemplary explanatory diagram for illustrating the overall display.

As illustrated in FIG. 7, if it is possible to draw (display) the display screens of all users within a single screen, respective operation contents (in FIG. 7, operations to jump based on date and time) are to be displayed within the single screen.

This allows two users to simultaneously perform operations for finding programs in the program listings. If the two users have different ranges of interest, the overall display including the display ranges of the two users is provided together with the display of the ranges of interest of the two users. This allows each user to know which specific range the other user is interested in.

When one of the two users selects and starts to reproduce a program while other of the two users stops the operation on the program listings, then both of the two users view the started program.

On the other hand, when for example one of the two users selects and starts to reproduce a program while the other of the two users selects and starts to reproduce another program, a program of a user with a priority order, if any, higher than a priority order of the other user is to be reproduced.

The remote controller managing device 100 then proceeds to S20, performs the received remote controller operation, and records the performance history before terminating the conflict detecting process (S20).

If it is determined at S13 that the screen display contents conflict with each other (No at S13), the remote controller managing device 100 determines whether operation contents conflict with each other (S17).

If it is determined at S17 that the operation contents do not conflict with each other (No at S17), the remote controller managing device 100 proceeds to S20, performs the received remote controller operation, and records the performance history before terminating the conflict detecting process (S20).

On the other hand, if it is determined at S17 that the operation contents conflict with each other (Yes at S17), the remote controller managing device 100 determines whether the operating terminal 200 that issued the received remote controller operation has a priority order higher than a priority order of the other operating terminal 200 (S18).

The priority order of the operating terminals 200 will be described below.

In the embodiment, each of the operating terminals 200 is provided with an operation authority and a priority order in advance.

The following settings (1) to (4) can be considered as settings for priority orders.

(1) A higher priority order is assigned to an operating terminal for which a login process is completed earlier.

(2) A specific priority order is set for each user in advance and the set priority order is assigned to the user as he or she logs in.

In this case, for example, the user manager 107 may store therein the priority orders associated with the respective user IDs.

(3) A higher priority order is assigned to an operating terminal 200 having no display screen, such as a dedicated remote controller.

(4) A logged-in terminal is assigned with a higher priority order than an unlogged-in terminal.

Next, a method for resolving conflicts based on the priority order is described.

As a method for resolving conflicts when the conflicts occur, it can be considered a method that provides priority to an operation of a remote controller having higher priority order, in accordance with the priority orders of the operation authority.

Specifically, there is considered a case when the user “Taro” has a priority order higher than a priority order of the user “Jiro” and these users select channels different from each other substantially at the same time (assuming that “Taro” selects channel 1 and “Jiro” selects channel 2).

In this case, if “Jiro” selects channel 2 first, channel 2 is instantaneously displayed, immediately followed by the display of channel 1 selected by “Taro”.

Conversely, if “Taro” selects channel 1 first, channel 2 selected immediately thereafter by “Jiro” is not displayed at all.

In this case, a predetermined threshold value is used for a time period after the operation by “Taro” is performed and during which the operation by “Taro” is not interrupted by the operation by “Jiro”.

Similarly, for a case in which each of multiple users continuously presses the remote controller button, it also becomes capable to continue performing operations without a user with higher priority to be interrupted by other user, by performing the operation in accordance with the priority orders.

Specifically, if it is determined at S18 that the operating terminal 200 that issued the received remote controller operation has a priority order higher than a priority order of the other operating terminal 200 (Yes at S18), the remote controller managing device 100 proceeds to S20, executes the received remote controller operation, and records the performance history before terminating the conflict detecting process (S20).

If it is determined at S18 that the operating terminal 200 that issued the received remote control operation has a priority order lower than the priority order of the other operating terminal 200 (No at S18), the remote controller managing device 100 notifies that the operation has been rejected, and terminating the conflict detecting process (S19).

As described above, if the operation contents conflict with each other, in accordance with the priority orders, the remote controller operation contents of the operating terminal 200 having higher priority order is executed while a notification indicating that the operation has been rejected is provided to the operating terminal 200 having lower priority order. Therefore, operations conflicting with each other are not to be actually preformed.

The aforementioned explanations has been directed to resolving conflicts, if any, based on the priority orders. However it is also possible to prevent occurrence of conflicts.

For example, it is possible to disable execution of an operation that conflicts with a remote controller with higher priority order at the timing when a priority order for the operation authority is established.

More specifically, it is possible to disable the delete function of a remote controller other than a remote controller having the highest priority order, i.e., a remote controller that does not have the highest priority order, so that the delete function cannot be executed by the remote controller that does not have the highest priority order.

Furthermore, any allowable operations may be selectably and executably displayed so as to be able to recognize that certain functions are limited.

For example, for a remote controller having buttons only, a method such as to only turn on a backlight of a button allowed to be operated or to physically lock a button so that the button cannot be pressed, can be considered.

Furthermore, it is possible not to allow a remote controller having lower priority order to change the display of the display 106, but to instead allow the remote controller having lower priority order to change the display content of the display 202 on the operating terminal 200.

Next, transferring of the operation authority will be described below.

The operation authority assigned to each operating terminal 200 is not permanent, and can be transferred through the method described below.

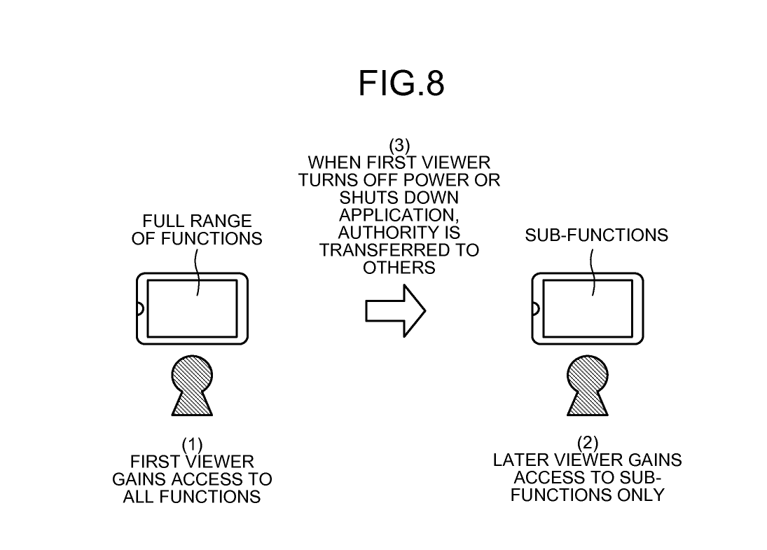

FIG. 8 is an exemplary explanatory diagram of an example of when an operation authority is transferred from an operating terminal of a user holding the operation authority to an operating terminal of other user.

An example of when the operation authority is transferred from the remote controller having high priority order is when the remote controller has not been operated for a certain period of time period and thereby a timeout condition is met, or as illustrate in FIG. 8, when an operation to finish viewing of the TV, such as a “power OFF” operation, is performed.

In this case, it is possible not to allow the user with no operation authority to perform any operations. However, it is also possible to allow the user having the operation authority (the user who views a program first) to perform (access) a full range of functions (all operations), while allowing the user with no operation authority (the user who views a program later) is to perform (access) only sub-functions (limited functions relative to the full range of functions).

Alternatively, it can be considered a method in which a remote controller having low priority order obtains the operation authority through an appropriate operation. For example, if the operating terminal 200 has an acceleration sensor, the acceleration sensor may be used to detect an operation to shake the operating terminal 200, thereby providing the operation authority to the operating terminal 200.

In case the operation authority is obtained or lost, feedback information (predetermined vibration, screen display, or voice reproduction) may be provided with respect to the remote controller. Consequently, operability thereof can be enhanced.

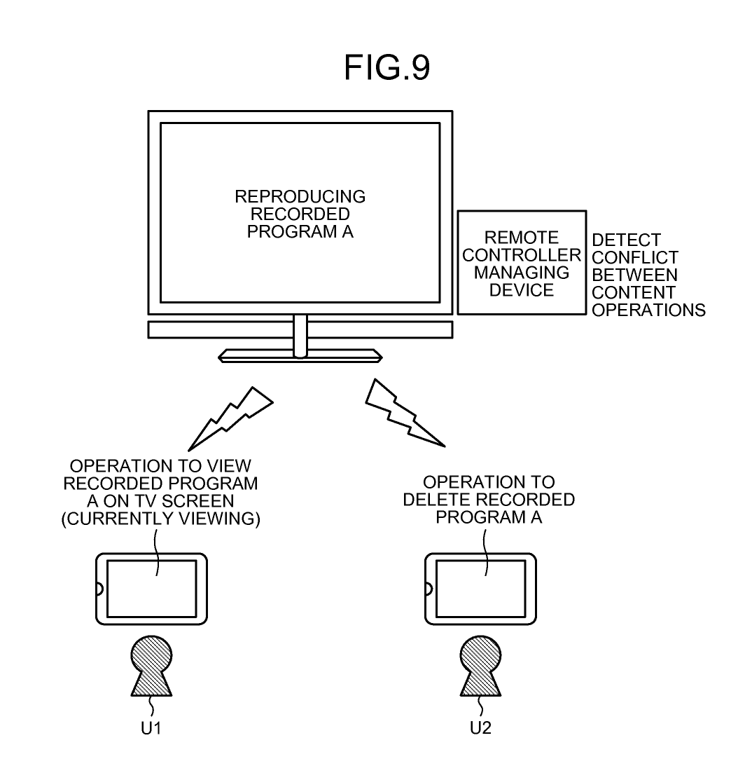

FIG. 9 is an explanatory diagram of resolving of conflicts among content operations.

When content operations conflict with each other, one of the users warns other one of the users at the time when the occurrence of conflicts is recognized, such as the timing when the other one of the user tries to execute the “delete” operation with respect to a recorded program on which the one of the user has executed the “reproduce” operation, as illustrated in FIG. 9 for example.

Alternatively, it is possible to perform a content protection operation. As a result, it becomes possible for the user who performed “delete” operation to display the string “successfully deleted” while deleting only the access authority thereof. Further, it becomes possible for the user who performed the “reproduce” operation to maintain the contents.

For example, it is considered a case in which a user “Taro” performs operations during the logged-in session while watching the display module 106 and a user “Jiro” has logged in and performs operations while watching the display 202 of his operating terminal 200. In this case, if the first user of these two users deletes content, that particular content disappears from the screen of the first user's; however, this simply adds to the deleter IDs as in FIG. 4 and that particular content is left intact on the screen of the second user's and the second user can still reproduce or otherwise operate that particular content.

Here, the content may actually be deleted in the above case when, for example, the user who has actually recorded the content deletes the content or the content recorded in the shared mode is deleted.

A case in which a conflict of the operation authority is detected will be described below.

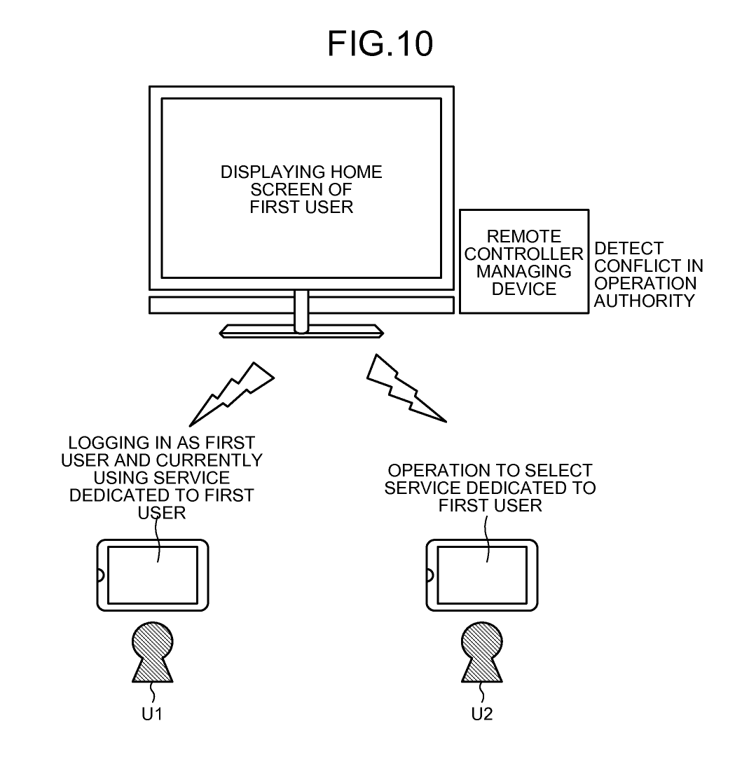

FIG. 10 is a diagram for illustrating resolving of conflict of the operation authority.

When conflict of the operation authority is detected, feedback information indicating that the operation is not permitted (predetermined vibration, screen display, or voice reproduction) is provided to the operating terminal 200 of the user who has no operation authority.

In this case, if a user having a high priority order performs the operation, he or she may have a setting to permit the operation.

A static or dynamic method may be employed for the detection of the conflict. According to the static method, a table may have prepared in advance. Here, the table manages a combination of an operating mode and a specific operation or operations enabled under the operating mode. Then, the table is referred to in determining whether conflict exists. Further, according to the dynamic method, the conflict may be detected when an operation is to be actually performed. Then, it is determined whether the operation to be performed conflicts with an operation being performed.

The foregoing description is based on the assumption that the priority orders are established for the operating terminals (remote controllers). The priority orders may nonetheless be dynamically changed as necessary.

For example, a distance between the operating terminal (remote controller) and the TV terminal may be used.

A method for measuring the distance maybe such that either the TV or the operating terminal (remote controller) is marked so as to be detectable by the counterpart and the marker is detected through image processing.

Alternatively, another method is to measure radio wave strength of the operating terminals (remote controllers) and the measurements are consolidated at the TV by a wired or wireless device. A specific operating terminal (remote controller) that is thereby estimated to be located closer to the TV is given a higher priority order. It is noted that, in this case, if an operating command is received from an operating terminal outside a predetermined range, the specific operating terminal may be authorized to use only part of the functions of the TV. Possible processing control, in this case, may be such that the specific operating terminal is allowed to set timer recording, but not to change the channel.

Alternatively, the priority order may be changed according to the communication system.

For example, it is considered a case in which the TV responds to both infrared communication and radio wave communication as the method for detecting signals from the operating terminal (remote controller). In this case, the operation through the infrared communication may be given a priority order higher than the priority order of the operation through the radio wave communication, because the signal detected through the infrared communication is estimated to be closer and transmitted in an operation in which the remote controller is oriented toward the TV.

The foregoing description has been made for a configuration in which the display and the main part of the TV are directly connected to each other. The controller of the TV may nonetheless be located at a remote site and connected via a wired or wireless network.

In addition, the operation exemplified in describing the detection of the conflict is only an example. Understandably, the conflict detection may be applied to other operations relating to images, voice, and other content services.

While a configuration of the remote controller managing device has not been described in detail, the remote controller managing device in the embodiment has an ordinary computer-based hardware configuration comprising a control unit such as a central processing unit (CPU), a storage unit such as a read only memory (ROM) and a random access memory (RAM), an external storage unit such as a hard disk drive (HDD) and a compact disc (CD) drive, a display unit such as a display, and an input unit such as a keyboard and a mouse.

A control program to be executed by the remote controller managing device in the embodiment may be provided by being recorded on a computer-readable recording medium, such as a compact disc read only memory (CD-ROM), a flexible disk (FD), a compact disc recordable (CD-R), and a digital versatile disk (DVD), in a file in an installable format or an executable format.

The control program to be executed by the remote controller managing device in the embodiment may also be configured so as to be stored in a computer connected to a network such as the Internet and to be downloaded over the network. The control program to be executed by the remote controller managing device in the embodiment may still be configured so as to be provided or distributed over a network such as the Internet.

The control program to be executed by the remote controller managing device in the embodiment may even be configured so as to be provided by being incorporated in, for example, a ROM in advance.

The control program to be executed by the remote controller managing device in the embodiment has a modular configuration comprising the above-described components (the contention determiner and the controller). For actual hardware, each component is loaded onto a main storage device as a result of the CPU (processor) reading the control program from the storage medium and running the loaded control program, which results in the contention determining module and the control module being generated in the main storage device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A remote controller managing device configured to output an operation instruction signal for controlling a target control device in accordance with operation instructions from a plurality of remote controllers, respectively, for controlling the target control device, the remote controller managing device comprising:
a conflict determining module configured to determine whether the operation instructions of the remote controllers conflict with each other when the operation instructions are issued by the remote controllers; and
a controller configured to control the target control device so as to correspond to one of the operation instructions of one of the remote controllers with a higher priority order based on predetermined priority orders when the conflict determining module determines that the operation instructions conflict with each other.

2. The remote controller managing device of claim 1, wherein the priority orders are set in accordance with operation modes of the remote controllers.

3. The remote controller managing device of claim 1, wherein
the controller is configured to assign an operation authority to one of the remote controllers in advance, and,
when the remote controllers issue the operation instructions with identical priority orders, the controller is configured to control the target control device so as to correspond to one of the operation instructions of the one of the remote controllers with the operation authority.

4. The remote controller managing device of claim 3, wherein the controller is configured to limit content of one of the operation instructions of one of the remote controllers with no operation authority.

5. The remote controller managing device of claim 3, wherein, when a predetermined operation is performed in one of the remote controllers with no operation authority, the controller is configured to transfer the operation authority to the one of the remote controllers that has performed the predetermined operation.

6. The remote controller managing device of claim 1, wherein, when one of the remote controllers issues one of the operation instructions that conflicts with other one of the operation instructions of other one of the remote controllers and execution of the one of the operation instructions causes the other one of the operation instructions unable to be executed, the controller is configured to provide a notification that the one of the operation instructions has been issued, while prohibiting execution of the one of the operation instructions.

7. The remote controller managing device of claim 6, wherein, with respect to one of the remote controllers to which the notification that the one of the operation instructions has been issued, execution of the one of the operation instructions is prohibited from when the notification is provided.

8. The remote controller managing device of claim 1, wherein the controller is configured to provide a notification indicating that one of the operation instructions has been rejected when one of the remote controllers issues the one of the operation instructions that conflict with other one of the operation instructions of other one of the remote controllers.

9. A control method performed by a remote controller managing device configured to output an operation instruction signal for controlling a target control device in accordance with operation instructions from a plurality of remote controllers, respectively, for controlling the target control device, the control method comprising:
determining whether the operation instructions of the remote controllers conflict with each other when the operation instructions are issued by the remote controllers; and
controlling the target control device so as to correspond to one of the operation instructions of one of the remote controllers with a higher priority order based on predetermined priority orders when the conflict determining module determines that the operation instructions conflict with each other.

10. A computer program product having a non-transitory computer readable medium including programmed instructions, wherein the instructions, when executed by a computer for controlling a remote controller managing device configured to output an operation instruction signal for controlling a target control device in accordance with operation instructions from a plurality of remote controllers, respectively, for controlling the target control device, cause the computer to perform:
determining whether the operation instructions of the remote controllers conflict with each other when the operation instructions are issued by the remote controllers; and
controlling the target control device so as to correspond to one of the operation instructions of one of the remote controllers with a higher priority order based on predetermined priority orders when the conflict determining module determines that the operation instructions conflict with each other.
